(19) United States
(12) Patent Application Publication
(10) Pub. No.: US 2006/0279786 A1
(43) Pub. Date: Dec. 14, 2006

(54) Display device and driving apparatus thereof

(76) Inventors: Dae-Jin Park, Incheon-si (KR); Young-Chol Yang, Seongnam-si (KR); Baek-Woon Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/450,813

(22) Filed: Jun. 9, 2006

(30) Foreign Application Priority Data
Jun. 10, 2005 (KR) 10-2005-0049915

(51) Int. Cl. G06F 15/00

(52) U.S. Cl. 358/2.1; 358/1.9

(57) ABSTRACT

A display device includes a plurality of pixels arranged in a matrix, a signal controller that is configured to convert an input image signal having a first frequency into a plurality of output image signals having a second frequency and provide the plurality of output image signals at an output, a gray voltage generating unit for generating a plurality of gray voltage sets corresponding to the plurality of output image signals, respectively, and a data driver for selecting data signals corresponding to the plurality of output image signals from one of the plurality of gray voltage sets and applying the data signals to the pixel.

This application claims priority to Korean Patent Application No. 10-2005-0049915 filed on Jun. 10, 2005, and all the benefits accruing therefrom under 35 U.S.C. §119, and the contents of which in its entirety are herein incorporated by reference.

### BACKGROUND OF THE INVENTION

(a) Field of the Invention

The present invention relates to a display device and a driving apparatus for the display device. More particularly, the present invention relates to a display device and a driving apparatus that convert an input image signal into a plurality of output image signals, for example upper and lower output image signals, and display images in accordance with the output image signals.

(b) Description of Related Art

Generally, a liquid crystal display (“LCD”) includes a liquid crystal (“LC”) panel assembly including two panels, one lower panel provided with pixel electrodes and the other upper panel provided with common electrodes, and an LC layer with dielectric anisotropy interposed therebetween. The pixel electrodes are arranged in a matrix and are connected to switching elements such as thin film transistors (“TFT”), which sequentially receive a data signal on a row by row basis. The common electrode covers the entire surface of the upper panel and is supplied with a common voltage Vcom. A pixel electrode, a common electrode and the LC layer form an LC capacitor in a circuit perspective, and the LC capacitor together with a switching element connected thereto comprise a basic unit of a pixel.

The LCD displays images by applying an electric field to the liquid crystal layer disposed between the two panels and regulating the strength of the electric field to determine transmittance of light passing through the liquid crystal layer. In order to protect the LC layer from deteriorating due to a one-directional electric field, the voltage polarity of the data signal is reversed for each frame, for each row, or for each dot with respect to the common voltage, or the polarities of the data signal and the common voltage are reversed.

However, reversing the polarities of the data signals causes a blurring phenomenon because it takes a long time for the LC capacitor to be charged to a target voltage due to the slow response time of the LC molecules. This problem is particularly bad for moving pictures. A motion blur results because an image is not changed to a desired image rapidly due to a low variation of the image.

To solve the above problems, an impulsive driving scheme, which inserts a black image between normal images, has been utilized.

The impulsive driving scheme has been implemented using two techniques. One technique is referred to as an impulsive emission technique in which the entire screen becomes black for a predetermined time by turning off the backlight lamps. In the second technique, cyclic resetting is performed by applying black data signals to the pixels at a predetermined period together with the normal data signals relating to a display.

However, for the impulsive driving scheme using either technique, the insertion of the black image during the predetermined time lowers the brightness of the screen.

### BRIEF SUMMARY OF THE INVENTION

In an exemplary embodiment of the present invention, a display device includes a plurality of pixels arranged in a matrix, a signal controller configured to convert an input image signal having a first frequency into a plurality of output image signals having a second frequency and provide the plurality of output image signals at an output, a gray voltage generating unit for generating a plurality of gray voltage sets corresponding to the plurality of output image signals, respectively, and a data driver for selecting data signals corresponding to the plurality of output image signals from one of the plurality of gray voltage sets and applying the data signals to pixels.

The pixels may have luminance defined by the data signals, and the amount of light provided by the plurality of output image signals may be equal to that provided by the input image signals.

One of the plurality of output image signals may have a minimum gray when the input image signal has a gray that is less than a predetermined gray.

One of the plurality of output image signals may have a maximum gray when the input image signal has a gray that is equal to or larger than a predetermined gray.

The plurality of output image signals may include a first output image signal and a second output image signal, and the first output image signal has a gray that is equal to or larger than a gray of the second output image signal.

The gray voltage generating unit may generate a first gray voltage set for the first output image signal and a second gray voltage set for the second output image signal.

The display device further includes a switching unit selecting and outputting the first gray voltage set and the second gray voltage set, in turn.

The signal controller includes a frame memory for storing the input image signal, a look-up table for storing the plurality of output image signals as a function of the input image signal and outputting the plurality of output image signals corresponding to the input image signal from the frame memory, and a multiplexer for selecting and outputting one of the plurality of output image signals from the look-up table based on a control signal.

In a further exemplary embodiment of the present invention, a driving apparatus of a display device having a plurality of pixels includes a signal controller for converting an input image signal having a first frequency into a plurality of output image signals having a second frequency and providing the plurality of output image signals at an output, a gray voltage generating unit for generating a plurality of gray voltage sets corresponding to the plurality of output image signals, respectively, and a data driver for selecting data signals corresponding to the plurality of output image signals from one of the plurality of gray voltage sets and applying the data signals to the pixel.

The pixels may have luminance defined by the data signals, and the amount of light provided by the plurality of output image signals may be equal to that provided by the input image signal.

One of the plurality of output image signals may have a minimum gray when the input image signal has a gray that is less than a predetermined gray.

One of the plurality of output image signals may have a maximum gray when the input image signal has a gray that is equal to or larger than a predetermined gray.

The plurality of output image signals may include a first output image signal and a second output image signal, and the first output image signal has a gray that is equal to or larger than a gray of the second output image signal.

The gray voltage generating unit may include a first gray voltage generator for generating a first gray voltage set for the first output image signal and a second gray voltage generator for generating a second gray voltage set for the second output image signal.

The driving apparatus may further include a switching unit for selecting and outputting the first gray voltage set and the second gray voltage set, in turn.

The switching unit may be an analog switch.

The signal controller may include a frame memory for storing the input image signal, and an image signal modifier for outputting the first and second output image signals based on the input image signal from the frame memory.

The image signal modifier may include a look-up table for storing the first and second output image signals as a function of the input image signal and outputting the first and second output image signals corresponding to the input image signal from the frame memory, and a multiplexer for selecting and outputting one of the first and second output image signals from the look-up table based on a control signal.

The second frequency may be twice the first frequency.

The first frequency may be about 60 Hz.

### BRIEF DESCRIPTION OF THE DRAWINGS

The present invention will become more apparent in light of the following detailed description of exemplary embodiments of the present invention with reference to the accompanying drawings, in which:

FIG. 1 is a block diagram of an exemplary embodiment of an LCD according to the present invention;

FIG. 2 is an equivalent circuit schematic diagram illustrating a structure of an exemplary embodiment of a pixel of the LCD of FIG. 1 according to the present invention;

FIG. 3 is a block diagram of an exemplary embodiment of a signal controller of the LCD of FIG. 1 according to the present invention;

FIG. 4 illustrates an exemplary embodiment of data voltages corresponding to an upper output image signal and a lower output image signal for grays of input image signals sought according to the present invention;

FIG. 5(a) illustrates a reversion form of application of data voltages corresponding to the upper output image signal to the first field;

FIG. 5(b) illustrates a reversion form of application of data voltages corresponding to the lower output image signal to the second field;

FIG. 6A is a block diagram of an example of another exemplary embodiment of a gray voltage generator and a data driver according to the present invention;

FIG. 6B is a block diagram of an example of another exemplary embodiment of a gray voltage generator, a switching unit and a data driver according to the present invention;

FIG. 7A is a graph illustrating gray voltages with respect to another exemplary embodiment of the upper output image signals having upper grays according to the present invention;

FIG. 7B is a graph illustrating gray voltages with respect to another exemplary embodiment of the lower output image signals having lower grays according to the present invention; and

FIG. 8 is a graph showing gamma curves with respect to exemplary embodiments of upper output image signals and lower output image signals according to the present invention.

### DETAILED DESCRIPTION OF THE INVENTION

The present invention is described fully below, with reference to the accompanying drawings, in which exemplary embodiments of the present invention are shown. The present invention may, however, be embodied in many different forms and the present invention is not limited to the exemplary embodiments set forth herein.

In the drawings, the thickness of layers and regions are exaggerated for clarity. Like numerals refer to like elements throughout. It will be understood that when an element such as a layer, film, region, substrate or panel is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, exemplary embodiments of a liquid crystal display and a driving apparatus thereof which are respective exemplary embodiments of a display device and a driving apparatus thereof according to the present invention are described below with reference to the drawings.

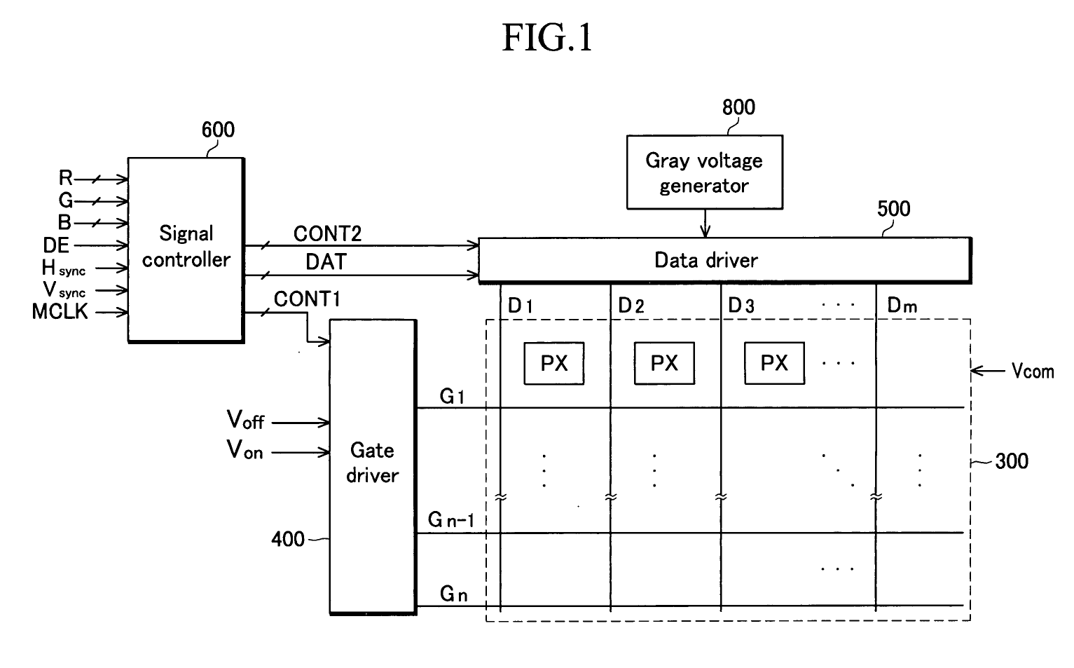

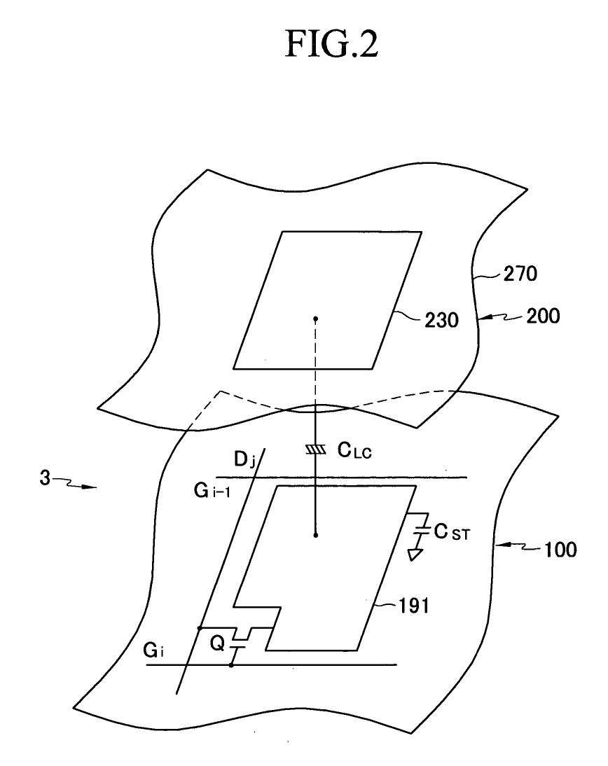

FIG. 1 is a block diagram of an exemplary embodiment of an LCD according to the present invention. FIG. 2 illustrates an equivalent circuit schematic diagram illustrating a structure of an exemplary embodiment of a pixel of the LCD of FIG. 1 according to the present invention.

Referring to FIG. 1, an exemplary embodiment of an LCD according to the present invention includes an LC panel assembly 300, a gate driver 400 and a data driver 500 connected to the LC panel assembly 300, a gray voltage generator 800 connected to the data driver 500, and a signal controller 600 for controlling the above-described elements.

Still referring to FIG. 1, the panel assembly 300 includes a plurality of signal lines G₁-Gₙ and D₁-Dₘ and a plurality of pixels PX connected to the signal lines G₁-Gₙ and D₁-Dₘ. The pixels PX are arranged substantially in a matrix. In a structural view shown in FIG. 2, the panel assembly 300 includes a lower panel 100, an upper panel 200 and an LC layer 3 interposed therebetween

Referring again to FIG. 1, the signal lines G₁-Gₙ and D₁-Dₘ include a plurality of gate lines G₁-Gₙ for transmitting gate signals (also referred to as “scanning signals”), and a plurality of data lines D₁-Dₘ for transmitting data signals. The gate lines G₁-Gₙ extend substantially in a row direction and are substantially parallel to each other, while the data lines D₁-Dₘ extend substantially in a column direction and are substantially parallel to each other.

Referring to FIG. 2, each pixel PX, for example a pixel PX connected to an i_th gate line Gᵢ (i=1, 2, . . . , n) and a j_th data line Dⱼ (j=1, 2, . . . , m) includes a switching element Q that is connected to the signal lines G₁-Gₙ and D₁-Dₘ, and an LC capacitor C_{LC} and a storage capacitor C_{ST} that are connected to the switching element Q. The storage capacitor C_{ST} may be omitted if it is unnecessary.

The switching element Q, such as a TFT, is provided on the lower panel 100 and has three terminals: a control terminal connected to one of the gate lines G₁-Gₙ; an input terminal connected to one of the data lines D₁-Dₘ; and an output terminal connected to the LC capacitor C_{LC} and the storage capacitor C_{ST}.

The LC capacitor C_{LC} includes a pixel electrode 191 on the lower panel 100, a common electrode 270 on the upper panel 200 and the LC layer 3 as a dielectric between the electrodes 191 and 270. The pixel electrode 191 is connected to the switching element Q via the output terminal of the switching element Q. The common electrode 270 covers the entire surface of the upper panel 200 and is supplied with a common voltage Vcom. Alternatively, both the pixel electrode 191 and the common electrode 270, which have shapes of bars or stripes, may be provided on the lower panel 100.

The storage capacitor C_{ST} is an auxiliary capacitor for the LC capacitor C_{LC}. The storage capacitor C_{ST} includes the pixel electrode 191 and a separate signal line (not shown), which is provided on the lower panel 100, which overlaps the pixel electrode 191 via an insulator, and is supplied with a predetermined voltage such as the common voltage Vcom. Alternatively, the storage capacitor C_{ST} includes the pixel electrode 191 and an adjacent gate line called a previous gate line, which overlaps the pixel electrode 191 via an insulator.

For color display, each pixel PX uniquely represents one of three colors such as red, green, and blue colors, and may also be primary colors (spatial division), or sequentially represents the three colors in time (temporal division), thereby obtaining a desired color. FIG. 2 shows an example of the spatial division in which each pixel PX includes a color filter 230 representing one of the three colors in an area of the upper panel 200 facing the pixel electrode 191. Alternatively, the color filter 230 is provided on or under the pixel electrode 191 on the lower panel 100.

One or more polarizers (not shown) for polarizing light are attached to outer surfaces of the lower and upper panels 100 and 200 of the panel assembly 300.

Referring to FIG. 1 again, the gray voltage generator 800 generates two sets of gray voltages (reference gray voltages) related to the transmittance of the pixels PX. The gray voltages in one set have a positive polarity (referred to as positive gray voltages) with respect to the common voltage Vcom, while those in the other set have a negative polarity (referred to as negative gray voltages) with respect to the common voltage Vcom.

The gate driver 400 is connected to the gate lines G₁-Gₙ of the panel assembly 300 and synthesizes the gate-on voltage Von and the gate-off voltage Voff from an external device (not shown) to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ. However, the data driver 500 may generate gray voltages for all of the grays by dividing the reference gray voltages and select the data voltages from the generated gray voltages when the gray voltage generator 800 generates reference gray voltages.

The signal controller controls the gate driver 400 and the data driver 500, etc.

Each of the driving units 400, 500, 600 and 800 may include at least one integrated circuit (“IC”) chip mounted on the LC panel assembly 300 or on a flexible printed circuit (“FPC”) film in a tape carrier package (“TCP”) type, which are attached to the panel assembly 300. Alternatively, at least one of the processing units 400, 500, 600 and 800 may be integrated with the panel assembly 300 along with the signal lines G₁-Gₙ and D₁-Dₘ and the switching elements Q. Alternatively, all the processing units 400, 500, 600 and 800 may be integrated into a single IC chip, but at least one of the processing units 400, 500, 600 and 800 or at least one circuit element in at least one of the processing units 400, 500, 600 and 800 may be disposed out of the single IC chip.

Now, the operation of the above-described LCD will be described in detail.

The signal controller 600 is supplied with input image signals R, G, and B and input control signals for controlling the display thereof from an external graphics controller (not shown). The input image signals R, G and B contain luminance information of each pixel PX, and the luminance has a predetermined number of, for example, 1024(=2¹⁰), 256(=2⁸) or 64(=2⁶) grays. The input control signals include a vertical synchronization signal Vsync, a horizontal synchronization signal Hsync, a main clock signal MCLK and a data enable signal DE, etc.

After generating gate control signals CONT1 and data control signals CONT2 and processing the image signals R, G and B to be suitable for the operation of the panel assembly 300 on the basis of the input control signals and the input image signals R, G and B, the signal controller 600 transmits the gate control signals CONT1 to the gate driver 400 and the processed image signals DAT and the data control signals CONT2 to the data driver 500.

The data processing operations of the signal controller 600 include conversion of the input image signal R, G and B having a predetermined frequency into a plurality of, for example, two output image signals having a different frequency from the incoming input image signal, for example, double the frequency of the input image data R, G and B for output. At this time, one of two grays with respect to the two output image signals based on the grays of the input image signals has a maximum gray or minimum gray. The operations of the signal controller 600 will be described below.

The gate control signals CONT1 include a scanning start signal STV for instructing to start scanning and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of a start of data transmission for a group of pixels PX, a load signal LOAD for instructing to apply the data voltages to the data lines D1-Dm, and a data clock signal HCLK. The data control signal CONT2 may further include an inversion signal RVS for reversing the polarity of the data voltages (with respect to the common voltage Vcom).

In response to the data control signals CONT2 from the signal controller 600, the data driver 500 receives a packet of the digital image data DAT for the group of pixels PX from the signal controller 600 and receives one of the two sets of gray voltages supplied from the gray voltage generator 800. The data driver 500 converts the image data DAT into analog data voltages selected from the gray voltages supplied from the gray voltage generator 800, and applies the data voltages to the data lines D₁-Dₘ.

The gate driver 400 applies the gate-on voltage Von to the gate line G₁-Gₙ in response to the gate control signals CONT1 from the signal controller 600, thereby turning on the switching elements Q connected thereto. The data voltages applied to the data lines D₁-Dₘ are supplied to the pixels PX through the activated switching elements Q.

The difference between the data voltage and the common voltage Vcom is represented as a voltage across the LC capacitor C_{LC}, which is referred to as a pixel voltage. The LC molecules in the LC capacitor C_{LC} have orientations depending on the magnitude of the pixel voltage, and the molecular orientations determine the polarization of light passing through the LC layer 3. The polarizer(s) converts light polarization to light transmittance such that the pixels PX display the luminance represented by the image data DAT.

By repeating this procedure by a unit of the horizontal period (which is denoted by “1H” and is equal to one period of the horizontal synchronization signal Hsync and the data enable signal DE), all gate lines G₁-Gₙ are sequentially supplied with the gate-on voltage Von during a frame, thereby applying the data voltages to all of the pixels PX.

When the next frame starts after one frame finishes, the inversion control signal RVS applied to the data driver 500 is controlled such that the polarity of the data voltages is reversed (which is referred to as “frame inversion”). The inversion control signal RVS may also be controlled such that the polarity of the data voltages flowing in a data line in one frame are reversed during one frame (for example, line inversion and dot inversion), or the polarity of the data voltages in one packet are reversed (for example, column inversion and dot inversion).

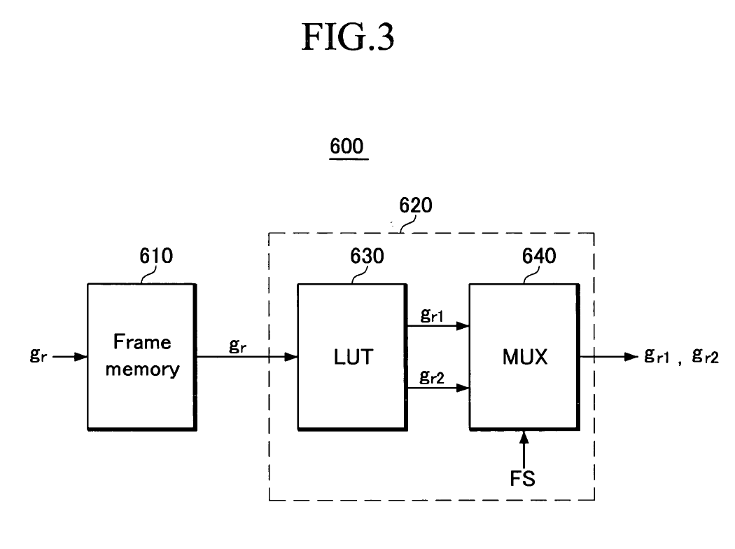

Next, the data signal processing operations of an exemplary embodiment of the signal controller 600 of an LCD according to the present invention will be described in detail with reference to FIG. 3

Referring to FIG. 3, the signal controller 600 includes a frame memory 610 and an image signal modifier 620 connected thereto.

The frame memory 610 stores inputted image signals by frame. The image signals stored in the frame memory 610 are referred to herein as “input image signals” and are denoted by “gᵣ.”

The image signal modifier 620 receives the input image signals gᵣ stored in the frame memory 610 sequentially and converts each of the input image signals gᵣ into a plurality of, for example, first and second output image signals gᵣ₁ and gᵣ₂, for output. In detail, the image signal modifier 620 reads the input image signal gᵣ once from the frame memory 610 and converts it into the first output image signal gᵣ₁ for sequential output, and subsequently reads the input image signal gᵣ once again therefrom and converts it into the second output image signal gᵣ₂ for sequential output. After applying data voltages corresponding to the first output image signal gᵣ₁ to the data lines D₁-Dₘ, the data driver 500 applies data voltages corresponding to the second output image signal gᵣ₂ to the data lines D₁-Dₘ. Hereinafter, periods when the first and second output image signals gᵣ₁ and gᵣ₂ are outputted and periods when the data voltage corresponding to the first and second output image signals gᵣ₁ and gᵣ₂ are applied are referred to as “a field”, respectively. The periods of the two fields are ½ H, respectively. The image signal modifier 620 is described below in detail.

Since the input image signal gᵣ stored in the frame memory 610 is read twice, a read frequency or an output frequency of the frame memory 610 is double that of a write frequency or an input frequency. Accordingly, when an input frame frequency of the frame memory 610 is 60 Hz, an output field frequency and a frequency for applying the data voltages are 120 Hz.

For the two output image signals gᵣ₁ and gᵣ₂, the sum of the amount of light from the pixels by the first and second output image signals gᵣ₁ and gᵣ₂ is the same as that by the input image signal gᵣ before modification. As used herein, the amount of light is equal to the luminance multiplied by the time for holding the luminance.

In this case, when a luminance corresponding to the input image signal gᵣ is assumed to be T(gᵣ), a luminance corresponding to the first output image signal gᵣ₁ is assumed to be T(gᵣ₁) and a luminance corresponding to the second output image signal T(gᵣ₂), [Equation 1] is as follows:
2T(gᵣ)=T(gᵣ₁)+T(gᵣ₂) [Equation 1]

In addition, one of tow grays Pᵣ₁ and Pᵣ₂ corresponding to the two output image signals gᵣ₁ and gᵣ₂, respectively, is larger than or the same as the other. That is, Pᵣ₁≧Pᵣ₂ or P_{r1≦P}ᵣ₂.

An output image signal having a larger gray voltage is referred to as an “upper output image signal”, and an output image signal having a smaller gray voltage is referred to as a “lower output image signal” of the two grays Pᵣ₁ and Pᵣ₂ corresponding to the two output image signals gᵣ₁ and gᵣ₂, and, at this time, the upper output image signal may be output first, or the lower output image signal may be output first. In this case, a field during output of the upper output image signal is referred to as “an upper field”, and a field during output of the lower output image signal is referred to as “a lower field”.

A light amount resulting from the lower output image signal preferably does not exceed about 50% of that resulting from the upper output image signal, and a gray of the lower output image signal becomes 0, i.e., a black gray, or becomes near thereto so that an effect of impulsive driving is given.

An exemplary embodiment for obtaining the upper output image signal and the lower output image signal for satisfying the above conditions and giving the effect of the impulsive driving is described below in detail.

In the present exemplary embodiment, for Pᵣ₁≧Pᵣ₂, the first output image signal gᵣ₁ having the gray Pᵣ₁ is referred to as an upper output image signal and the second output image signal gᵣ₂ having the gray Pᵣ₂ is referred to as a lower output image signal, and the upper output image signal is assumed to be output prior to the lower output image signal.

When the input image signal gᵣ stored in the frame memory 610 is 8 bits, the gray Pᵣ of the input image signal ranges from 0 to 255, and the luminance T(gᵣ) of the input image signal gᵣ having the gray Pᵣ has the following relationship.
T(gᵣ)=α(Pᵣ/255)γ

When γ=2.5 and the gray Pᵣ of the input image signal gᵣ is 192, a luminance for 192 corresponds to a half of that for 255, the highest gray. Accordingly, the gray Pᵣ₁ of the upper output image signal gᵣ₁ and the gray Pᵣ₂ of the lower output image signal gᵣ₂ is determined as follows:
if 0≦Pᵣ≦192, Pᵣ₁=(255/192)×Pᵣ₁, Pᵣ₂=0; and (1)
if 193≦Pᵣ≦255, Pᵣ₁=255, Pᵣ₂=T⁻¹[2T(Pᵣ)−T(255)]. (2)

That is, when the gray Pᵣ of the input image signal gᵣ is in the range (1), the gray Pᵣ₁ is the upper output image signal gᵣ₁ and is determined as the highest gray, 255, and depending on the gray Pᵣ of the input image signal gᵣ₁ the gray Pᵣ₂ of the lower output image signal gᵣ₂ is 0.

When the gray Pᵣ of the input image signal gᵣ is in the range (2), the gray Pᵣ₁ of the upper output image signal gᵣ₁ has the highest gray, 255, and the gray Pᵣ₂ of the lower output image signal gᵣ₂ has a value satisfying Equation 1. When the gray Pᵣ of the input image signal gᵣ is 255, both the gray Pᵣ₁ of the upper output image signal gᵣ₁ and the gray Pᵣ₂ of the lower output image signal gᵣ₂ data become 255.

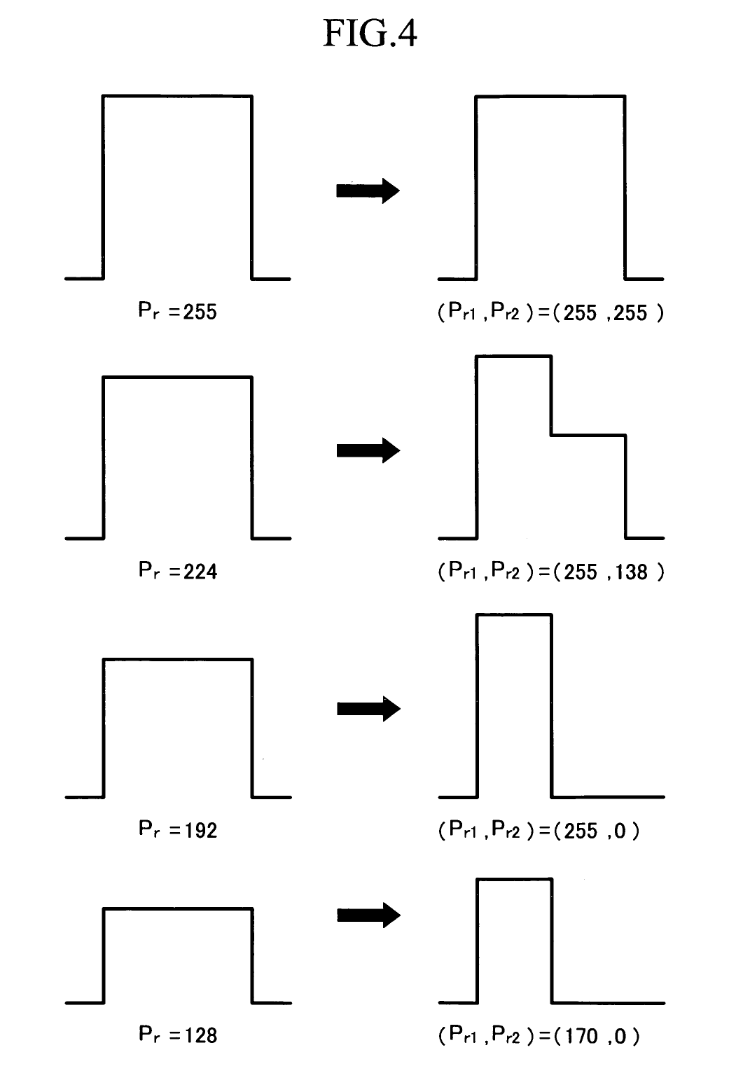

When the grays Pᵣ of the input image signal gᵣ are 128, 192, 224 and 255, respective data voltages corresponding to the respective upper output image signal gᵣ₁ and the respective lower output image signal gᵣ₂ obtained by the relations (1) and (2) are shown in FIG. 4.

As shown in FIG. 4, on application of the data voltages corresponding to the output image signal gᵣ₁ and gᵣ₂ during each field, when the gray Pᵣ of the input image signal gᵣ is lower than 192, the gray Pᵣ₁ of the upper output image signal gᵣ₁ is selected in a range lower than 255, the highest gray. At this time, the gray Pᵣ₁ of the upper output image signal gᵣ₁ is larger than the gray Pᵣ of the input image signal gᵣ. Since the data voltages corresponding to the respective output image signal gᵣ₁ and gᵣ₂ are applied to the corresponding pixels during the first and second fields, the period when the data voltages corresponding to the upper or lower output image signal gᵣ₁ and gᵣ₂ are applied to the pixels is reduced by about ½ relative to that when the data voltages corresponding to the input image signal gᵣ are applied thereto. Accordingly, data voltages that are larger than the data voltages corresponding to the input image signal gᵣ need to be applied to the pixels so that an amount of light that is almost the same as that resulting from the input image signal gᵣ may be obtained. In this case, since only the data voltages corresponding to the upper output image signal gᵣ₁ can substantially provide the light amount by the input image signal gᵣ, the gray Pᵣ₂ of the lower output image signal gᵣ₂ becomes 0 in order to give the impulsive driving effect.

However, when the gray Pᵣ of the input image signal gᵣ exceeds 192, and in this case the gray Pᵣ₂ of the lower output image signal gᵣ is 0, although the gray Pᵣ₂ of the upper output image signal gᵣ₁ is selected to be 255, the highest gray, a light amount that is the same as that resulting from the input image signal gᵣ cannot be obtained. That is, a loss of luminance occurs. Accordingly, the gray Pᵣ₂ of the lower output image signal gᵣ₂ is selected to be a value larger than 0 so that the insufficient light amount is compensated by the light amount by the lower output image signal gᵣ₂. Although the gray Pᵣ₂ of the lower image data gᵣ₂ giving the impulsive driving effect is not 0, the gray Pᵣ₂ thereof has a lower gray, for example a gray near 0, and thus the impulsive driving effect is obtained to some degree.

Operation of the signal controller 600 that transmits the two output image signals gᵣ₁ and gᵣ₂ obtained in this way to the data driver 500 is described below with reference to FIG. 3.

As described above, the signal controller 600 includes the frame memory 610 and the image signal modifier 620. The image signal modifier 620 includes a look-up table (“LUT”) 630 connected to the frame memory 610 and a multiplexer (“MUX”) 640 connected to the LUT 630 and receiving a field selecting signal FS. The field selecting signal FS is determined in many ways, such as odd-numbered and even-numbered fields, or by using a counter. In addition, the field selecting signal FS may be generated in the internal signal controller 600 or may be provided from an external device (not shown).

The LUT 630 of the image signal modifier 620 stores the upper output image signal gᵣ₁ and the lower output image signal gᵣ as a function of the input image signal gᵣ. Accordingly, the LUT 630 responds to the input image signal gᵣ to output the upper and lower output image signals gᵣ₁ and gᵣ₂ to the multiplexer 640.

The multiplexer 640 selects one of the upper and lower output image signals gᵣ₁ and gᵣ₂ from the LUT 630, depending on the field selecting signal FS, for sequential output to the data driver 500.

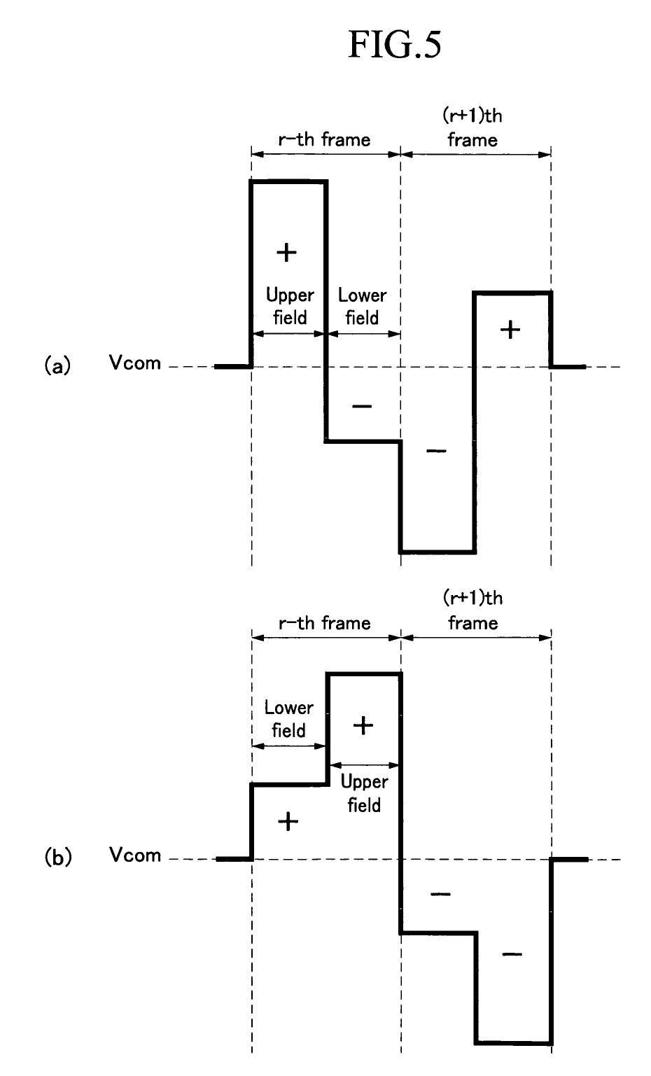

The data voltages corresponding to the upper output image signal gᵣ₁ and the lower output image signal gᵣ₂ applied to the pixels PX via the data lines D₁-Dₘ through the data driver 500 as described above have reversion forms as shown in FIG. 5. FIG. 5(a) illustrates the reversion form on application of the data voltages corresponding to the upper output image signal gᵣ₁ to the first field, and FIG. 5(b) illustrates the reversion form on application of the data voltages corresponding to the lower output image signal gᵣ₂ to the second field.

Polarities of the data voltages corresponding to the upper output image signal gᵣ₁ have to be identical to those of a previous field adjacent thereto so that a charging speed of pixels PX by the upper output image signal gᵣ₁ affecting images is reduced.

In addition, the polarities of the data voltages corresponding to the upper output image signal gᵣ₁ have to be reversed for each frame and those of the data voltages corresponding to the lower output image signal gᵣ₂ have to be reversed for each frame, and thus an average for a pixel voltage is not inclined to either a positive polarity or a negative polarity.

Accordingly, when the upper output image signal gᵣ₁ is applied during the first field, the polarities of the data voltages applied during two fields are opposite to each other and those applied during adjacent frames are also opposite, and the polarity of each pixel is reversed for two fields, as shown in FIG. 5(a).

When the upper output image signal gᵣ₁ is applied during the second field, the polarities of the data voltages applied during two fields within one frame are identical and those applied during two adjacent frames are opposite to each other, and each pixel is reversed for two fields, as shown in FIG. 5(b).

Next, another exemplary embodiment of an LCD according to the present invention will be described with reference to FIGS. 6A to 7B and FIGS. 1 and 3.

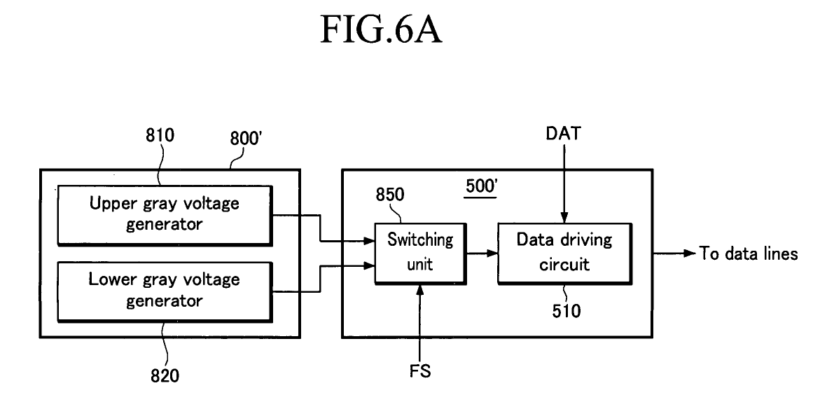

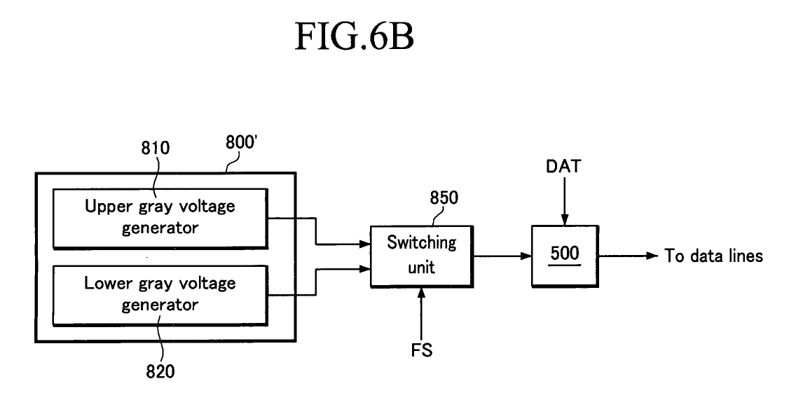

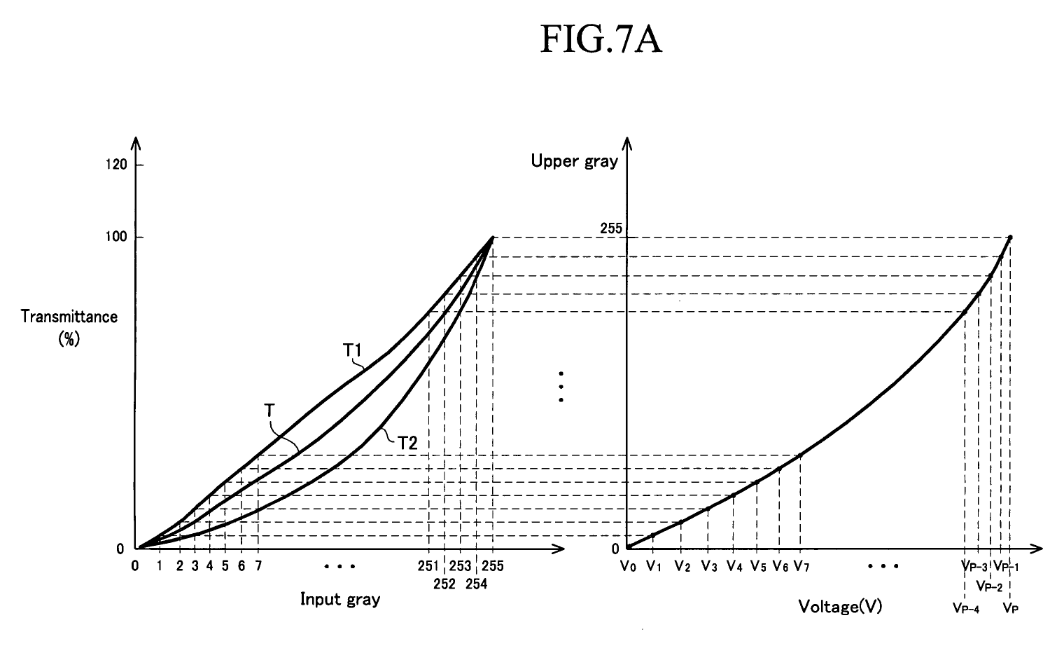

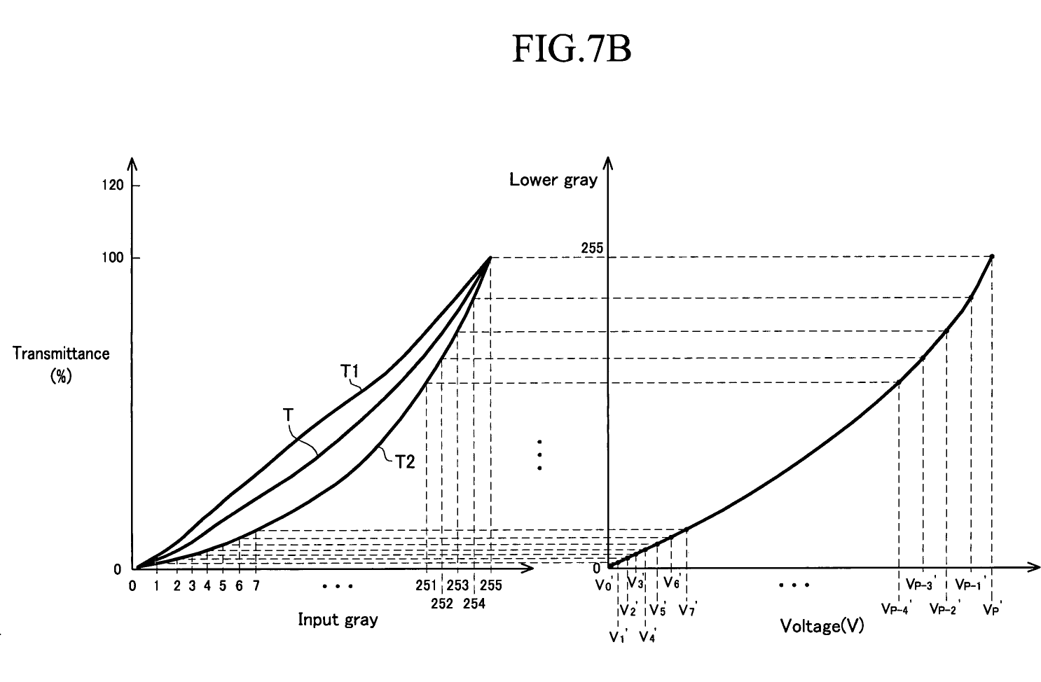

The structures and operations of the another exemplary embodiment of the LCD according to the present invention are almost the same as that shown in FIG. 1, except for the gray voltage generating unit 800′ and the data driver 500′. Thereby the elements performing the same operations are indicated as the same reference numerals, and the detailed description thereof is omitted. Accordingly, only the gray voltage generating unit 800′ and the data driver 500′ will be described in detail below. FIGS. 6A and 6B are block diagrams of respective other exemplary embodiments of gray voltage generators and data drivers according to the present invention, FIG. 7A is a graph illustrating gray voltages with respect to another exemplary embodiment of the upper output image signals having upper grays according to the present invention. FIG. 7B is s a graph illustrating gray voltages with respect to another exemplary embodiment of the lower output image signals having lower grays according to the present invention Referring to FIG. 6A, the gray voltage generating unit 800′ includes an upper gray voltage generator 810 and a lower gray voltage generator 820. The data driver 500′ includes a switching unit 850 and a data driving circuit 510 connected to the switching unit 850. The switching unit 850 selects one of two gray voltage sets from the two gray voltage generators 810 and 820 based on a field selection signal FS. The data driving circuit 510 has the same structure as that of the data driver 500 shown in FIG. 5, and therefore a description of the operations of the data driving circuit 510 is omitted.

The structures and operations of the LCD shown in FIG. 6B are the same as those of the LCD shown in FIG. 6A, except that the switching unit 850 is designed as a separate element disposed outside of the data driver 500, as opposed to that shown in FIG. 6A.

The switching unit 850 may be an analog switch of which a state is varied in accordance with the field selection signal FS.

The upper gray voltage generator 810 and the lower gray voltage generator 820 include resistor strings for respectively generating a plurality of voltages.

As described above with reference to FIG. 3, when an upper output image signal gᵣ₁ and a lower output image signal gᵣ₂ are stored in the look-up table 630 of the signal controller 600 as a function of an input image signal gr, transmittance curves (referred to as “gamma curves”) with respect to the grays Pᵣ, Pᵣ₁ and Pᵣ₂ corresponding to the image signals gᵣ, gᵣ₁ and gᵣ₂, are respectively represented, and, as shown in FIG. 7, the curves are denoted as “T”, “T1” and “T2”, respectively.

Among a plurality of gray voltages from the upper gray voltage generator 810, the gray voltages V0, V1, V2, V3, . . . are based on the gamma curve T1 with respect to the upper output image signals gᵣ₁ (as shown in FIG. 7A) and the gray voltages V0′, V1′, V2, V3′, . . . are based on the gamma curve T2 with respect to the lower output image signals gᵣ₂ (as shown in FIG. 7B).

When the two gray voltage sets from the upper and lower gray voltage generators 810 and 820 are defined based on the gamma curves T1 and T2, respectively, the operations of the data driver 500′ or 500, which select the corresponding gray voltages from the two gray voltage generators 810 and 820, will be described.

The upper and lower output image signals gᵣ₁ and gᵣ₂ corresponding to the input image signal gᵣ are sequentially applied as image signals DAT to the data driver 500′ or 500, and the field selection signal FS applied from the multiplexer 640 of the signal controller 600 is applied to the switching unit 850.

The switching unit 850 selects one set of the two gray voltage sets V0, V1, V2, V3, . . . or V0′, V1′, V2′, V3′, . . . from the upper and lower gray voltage generators 610 and 620 based on a state of the field selection signal FS, to apply the selected gray voltage set to data driving circuit 510 (or data driver 500).

The data driving circuit 500 (or data driver 500) selects gray voltages corresponding to the digital image signals DAT from the selected gray voltage set and applies the selected gray voltages as data signals.

As described above, since the exemplary embodiment of the LCD according to the present invention includes the two gray voltage generators for generating the gray voltages for the upper and lower output image signals gᵣ₁ and gᵣ₂ respectively, the LCD represents all of the grays with respect to the upper and lower output image signals gᵣ₁ and gᵣ₂, which will be described in further detail below.

For example, when the total number of represented grays is 256, if the gray voltage generating unit 800′ includes only one gray voltage generator, the number of gray voltages of positive polarity is 256 and the number of gray voltages of negative polarity is also 256. Also, the number of transmittances of the upper output image signals gᵣ₁ and the number of transmittances of the lower output image signals gᵣ₂ with respect to the input grays of 256 are 256. If it is assumed that there are no transmittances having the same value among the transmittances of the upper output image signal gᵣ₁ and the lower output image signal gᵣ₂, the total number of transmittances corresponding to the input grays of 256 is 512. That is, to represent all of the transmittances corresponding to the upper and lower output image signals gᵣ₁ and gᵣ₂, a total of 512 gray voltages are needed when only the positive polarity gray voltages or the negative polarity gray voltages are considered.

However, when the gray voltage generating unit 800′ includes only one gray voltage generator, only 256 gray voltages are generated with respect to the positive and negative polarities. Thereby, gray voltages with respect to the remaining 256 transmittances are not generated, and thereby grays with respect to the upper and lower output image signals gᵣ₁ and gᵣ₂ are not exactly represented.

Although there are a few upper and lower output image signals gᵣ₁ and gᵣ₂ having substantially equal transmittances, the gradients of the gamma curves T1 and T2 of the upper and lower output image signals gᵣ₁ and gᵣ₂ are different from each other and transmittance variations are not uniform in accordance with intervals. Thereby, the total number of transmittances with respect to the output image signals gᵣ₁ and gᵣ₂ significantly exceeds 256.

As described above, when the gray voltage generating unit 800′ includes one gray voltage generator, not all the grays with respect to the upper and lower output image signals gᵣ₁ and gᵣ₂ are represented.

However, in the exemplary embodiment of the LCD according to the present invention, the gray voltage sets are generated from the gray voltage generators 810 and 820 corresponding to the respect upper and lower output image signals gᵣ₁ and gᵣ₂, respectively, and all of the grays with respect to the upper and lower output image signals gᵣ₁ and gᵣ₂ are represented. Furthermore, one input image signal is converted into two output image signals having corresponding grays through the digital signal process, and thereby a quantization error caused by signals having values not to be digitally represented such as values below a decimal point decreases.

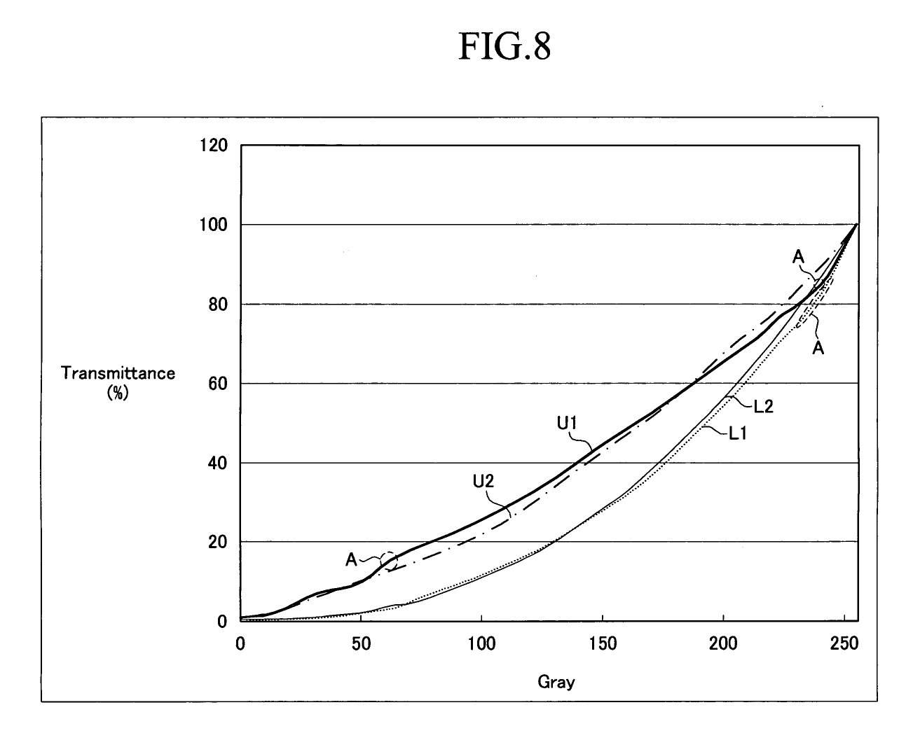

When the gray voltage generating unit includes one gray voltage generator as in the first exemplary embodiment shown in FIG. 1 and when the gray voltage generating unit includes two gray voltage generators as in the second exemplary embodiment shown in FIG. 6A or FIG. 6B, gamma curves with respect to the respective upper and lower output image signals are as shown in FIG. 8.

FIG. 8 shows gamma curves with respect to exemplary embodiments of upper output image signals and lower output image signals according to the present invention.

Referring to FIG. 8, a transmittance curve with respect to the gray voltages according to the first exemplary embodiment of the present invention is compared to a transmittance curve with respect to the gray voltages according to the second exemplary embodiment of the present invention.

Still referring to FIG. 8, when one gray voltage generator 800 according to the first exemplary embodiment of the present invention is used, as shown in the gamma curve U1 of the upper output image signals and the gamma curve L1 of the lower output image signals, the gradient variations of the gamma curves U1 and L1 have intervals “A”, of which the gradients are suddenly and largely varied instead of having sequential variation. The sudden transmittance variations based on the curves U1 and L1 are caused by the image deterioration.

However, when two gray voltage generators 810 and 820 according the second exemplary embodiment of the present invention are used, the gamma curve U2 of the upper output image signals and the gamma curve L2 of the lower output image signals are without the intervals having a sudden gradient variation such as “A”, while the gradients of the curves U2 and L2 are substantially uniform over all of the intervals of the curves U2 and L2. Thereby, the transmittance variations based on the curves U2 and L2 is sequentially varied, to improve image quality.

In the exemplary embodiments of the present invention, there are a plurality of the upper output image signals and lower output image signals having the same grays as each other with respect to the input image signal having the grays different from each other. Thereby, the upper output image signal and the lower output image signals are not matched one-to-one with the input image signals, and it is difficult to adjust the resistance value of the resistor strings of the gray voltage generator. Moreover, after adjusting the resistance value, for varying the grays of the upper and lower output image signals in accordance with characteristics of an LCD, the image signal modifier of the signal controller, which has a look-up table, is used.

In addition, by using the image input signals and the switching unit instead of the look-up table, one of a plurality of gray voltage generators is selected, to select a gray voltage set suitable for the input image signals.

The above exemplary embodiments may be used in display devices that convert an input image signal into a plurality of output image signals, for example upper and lower output image signals, and display images in accordance with the output image signals.

According to the present invention, the conversion of the input image signal to a plurality of output image signals improves the luminance and reduces image deteriorations such as an image sticking or a blurring phenomenon by the impulsive driving effect.

Moreover, according to the present invention, since the gray voltage generators for a plurality of output image signals such as the upper and lower output image signals are designed, data voltages that are suitable for the plurality of output image signals are selected from gray voltages from the corresponding gray voltage generator and applied to the data lines, and thereby luminance distortion is reduced and image quality is improved.

All of the grays with respect to the upper and lower output image signals, respectively, are represented by using the gray voltage generators for the upper and lower output image signals, and thereby image quality is improved.

While the present invention has been described in detail with reference to the exemplary embodiments, it is to be understood that the present invention is not limited to the disclosed exemplary embodiments, but, on the contrary, is intended to cover various modifications and equivalent arrangements included within the sprit and scope of the appended claims.

What is claimed is:

1. A display device comprising:
a plurality of pixels arranged in a matrix;
a signal controller configured to convert an input image signal having a first frequency into a plurality of output image signals having a second frequency and provide the plurality of output image signals at an output;
a gray voltage generating unit in operable communication with the signal controller, the gray voltage generating unit generates a plurality of gray voltage sets corresponding to the plurality of output image signals, respectively; and
a data driver in operable communication with the signal controller, the data driver selects data signals corresponding to the plurality of output image signals from one of the plurality of gray voltage sets and applies the data signals to pixels.

2. The display device of claim 1, wherein the pixels have luminance defined by the data signals, and the amount of light provided by the plurality of output image signals is equal to that provided by the input image signals.

3. The display device of claim 2, wherein one of the plurality of output image signals has a minimum gray when the input image signal has a gray that is less than a predetermined gray.

4. The display device of claim 2, wherein one of the plurality of output image signals has a maximum gray when the input image signal has a gray that is equal to or larger than a predetermined gray.

5. The display device of claim 1, wherein the plurality of output image signals comprise a first output image signal and a second output image signal, and the first output image signal has a gray that is equal to or larger than a gray of the second output image signal.

6. The display device of claim 5, wherein the gray voltage generating unit generates a first gray voltage set for the first output image signal and a second gray voltage set for the second output image signal.

7. The display device of claim 6, further comprising a switching unit selecting and outputting the first gray voltage set and the second gray voltage set, in turn.

8. The display device of claim 1, wherein the signal controller comprises:
a frame memory for storing the input image signal;
a look-up table for storing the plurality of output image signals as a function of the input image signal and outputting the plurality of output image signals corresponding to the input image signal from the frame memory; and
a multiplexer for selecting and outputting one of the plurality of output image signals from the look-up table based on a control signal.

9. A driving apparatus of a display device having a plurality of pixels, comprising:
a signal controller converting an input image signal having a first frequency into a plurality of output image signals having a different second frequency and providing the plurality of output image signals at an output;
a gray voltage generating unit in operable communication with the signal controller, the gray voltage generating unit generates a plurality of gray voltage sets corresponding to the plurality of output image signals, respectively; and
a data driver inoperable communication with the signal controller, the data driver selects data signals corresponding to the plurality of output image signals from one of the plurality of gray voltage sets and applies the data signals to the pixel.

10. The driving apparatus of claim 9, wherein the pixels have luminance defined by the data signals, and the amount of light provided by the plurality of output image signals is equal to that provided by the input image signal.

11. The driving apparatus of claim 10, wherein one of the plurality of output image signals has a minimum gray when the input image signal has a gray that is less than a predetermined gray.

12. The driving apparatus of claim 10, wherein one of the plurality of output image signals has a maximum gray when the input image signal has a gray that is equal to or larger than a predetermined gray.

13. The driving apparatus of claim 9, wherein the plurality of output image signals comprise a first output image signal and a second output image signal, and the first output image signal has a gray that is equal to or larger than a gray of the second output image signal.

14. The driving apparatus of claim 13, wherein the gray voltage generating unit comprises a first gray voltage generator for generating a first gray voltage set for the first output image signal and a second gray voltage generator for generating a second gray voltage set for the second output image signal.

15. The driving apparatus of claim 14, further comprising a switching unit for selecting and outputting the first gray voltage set and the second gray voltage set, in turn.

16. The driving apparatus of claim 15, wherein the switching unit is an analog switch.

17. The driving apparatus of claim 13, wherein the signal controller comprises:
a frame memory for storing the input image signal; and
an image signal modifier for outputting the first and second output image signals based on the input image signal from the frame memory.

18. The driving apparatus of claim 17, wherein the image signal modifier comprises:
a look-up table for storing the first and second output image signals as a function of the input image signal and outputting the first and second output image signals corresponding to the input image signal from the frame memory; and
a multiplexer for selecting and outputting one of the first and second output image signals from the look-up table based on a control signal.

19. The driving apparatus of claim 13, wherein the second frequency is twice the first frequency.

20. The driving apparatus of claim 19, wherein the first frequency is about 60 Hz.
